(19) United States
(12) Patent Application Publication
(10) Pub. No.: US 2021/0377325 A1
(43) Pub. Date: Dec. 2, 2021

(54) Human Interface for the Immediate Selection of Digital Content

(71) Applicant: David Kent, Isleton, CA (US)

(72) Inventor: David Kent, Isleton, CA (US)

(21) Appl. No.: 15/929,989

(22) Filed: Jun. 1, 2020

(51) Int. Cl. H04L 29/06; H04H 60/15; H04H 60/33

(52) U.S. Cl. CPC H04L 65/4084; H04H 60/33; H04H 60/15

(57) ABSTRACT

A means of selecting digital content from a broadcast network, such as a digital media streaming service, without searching, browsing or missing out on the selection process by having content chosen for the consumer by the network. This is accomplished by simplifying the selection implementation, deliberately restricting the number of choices, and making content readily available during the selection process and immediately once a choice has been made by the consumer. The invention is predicated on the idea that if the consumer relies on the material itself to identify its own source, type or other characteristics, either implicitly or explicitly, then consuming becomes selecting. By eliminating searching, browsing and other metadata interference, the discovery and enjoyment of digital content is enhanced.

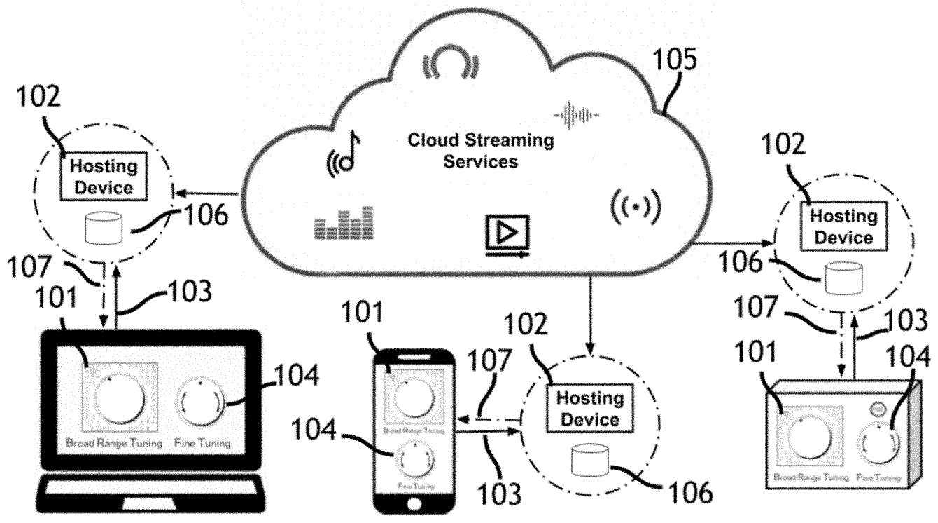

### TECHNICAL FIELD

Human-Machine Interaction, wherein devices are displaced or positioned by the user by means of virtual or physical coupling, primarily by touch, in order to make digital content immediately accessible without confusion or delay.

### BACKGROUND OF THE PRIOR ART

With the advent of broadcast networks, a vast selection of media content based on channel and time has been made available to a worldwide audience. With the evolution of cable and digital technologies, streaming media in particular, this same broadcast paradigm persists but the selection and access processes required of a consumer are vastly more complicated, perilous and off-putting due to an evolutionary stage being missed: namely, the self-identification of content. With the arbitrary coupling of metadata to content in the digital stream, a selection to be made on the part of the consumer now requires knowledge of this often complex metadata. In a misguided attempt to inform, now a consumer is required to “browse” or “search”. The density of the data provided requires a sifting and preference determination that interferes with the ready enjoyment and discovery of media content.

### BACKGROUND OF THE INVENTION

“Search-less” content selection is something consumers need to be reminded of again. “Selection” in its pure form is a single operation, whereby access to content and exercising a preference become one and the same operation, and may occur by means of an intuitive gesture. The compromise made to accomplish this as described is actually an advantage for broadcast networks: the imposition of scarcity and the promotion of quality. The need for compromise arises from the limitations of a single human gesture to be refined enough to pick from a virtually unlimited number of sources. Therefore, imposing a strategic limit on the resolution of this selection to fit the goals of a broadcast network serves not only to improve the convenience and accuracy of the human-initiated results but to also promote the most relevant and high-quality content within a limited range of availability.

### SUMMARY OF THE INVENTION

This invention specifies a human-machine interface consisting of one or more stages of precision refinement, where each stage is manipulable by human interaction, primarily touch or its general alternative for special cases. The indications of a successful selection may be achieved first by visual inspection of the position of one or more manipulable devices at each stage, implemented virtually in one embodiment, such as by means of an interactive presentation on a computer screen, or physically in another embodiment such as by means of a rotating or sliding knob, and perhaps assisted by calibration marks, possibly labeled, that correlate the current position of a device. The implementation method of any stage does not have to match any other within the same embodiment. It is presumed that a hosting device that can receive, store or otherwise produce digital media content, such as a mobile device application connected to an Internet streaming service, can read and respond to the current position of said selection devices. Secondly, indications of a successful selection are achieved by providing immediate and direct access to digital content by the hosting device, thereby allowing an observer to detect the nature, source or type of the content for themselves as consumed, perhaps assisted by any deliberate self-identification that may be contained within the content itself and possibly introduced by the broadcast network for precisely this purpose. A key facet of the invention is the deliberate limitation of precision at every stage. For a provider of the source material, this affords a natural selection process to promote the most desirable material since the precision of the selection process is thereby limited to a fixed number of choices.

It is further presumed that the hosting device may be capable of connecting to more than one source of digital content, such as multiple Internet streaming services, and/or serving digital content from a local or remote digital file storage system. If so, the particular response to the human-machine interface as described herein could be programmatically different in order to best serve the needs of consumers on that network. For example, the level of precision and associated limit values could vary depending on the network providing the source material. Another possible response would be to “spread” active channels over possibly empty channels that are “off the air” due to lack of available content or scheduling criteria, such as a “live” channel having nothing to broadcast at a particular time. This method would prevent a silent or “empty” channel from being selected unexpectedly by a consumer.

### BRIEF DESCRIPTION OF THE DRAWING

Some example embodiments of the invention in context with its presumed dependent components are illustrated in the Drawing and are not to be considered limiting with respect to any other possible embodiments, which could conform to the claims of the invention. Accordingly:

The Drawing depicts sources of available digital content that are made available to a Hosting Device, such as a computer or mobile device software application, or embedded hardware, software or hybrid components of a dedicated physical device, for which no specific claims are made about its type or implementation, which is capable of reading parameters from the invention in one or more embodiments that correspond to an operator selecting a digital source, and optionally taking control of the selection process in order to produce some form of automatic behavior.

### DETAILED DESCRIPTION OF THE DRAWING

The Drawing depicts 3 embodiments of the invention that each choose 2 stages of precision, for illustrative purposes. The 1st stage, Broad Range Tuning (101), is intended to represent the initial level of selection precision, which is arbitrarily confined to 55 steps in this embodiment. What is required by the invention is that some limit be applied in order to minimize the need for human dexterity in controlling the selection process by touch, to create a strategic scarcity of content sources for the benefit of the network accessed by the Hosting Device (102), or for other purposes. It is possible for some embodiments to allow the Hosting Device (102) to set this limit dynamically, but in these embodiments it is fixed by design. The condition of the selection process, underway or at rest, is communicated to the Hosting Device (102) as input parameters (103), which can have changing values over time and could contain information about the position, velocity, or other factors related to the condition of the invention as influenced by human manipulation.

The 2nd stage of precision, Fine Tuning (104), is similar to Broad Range Tuning (101) except for a multi-rotational design that allows an unspecified number of additional selections to occur within a single selection that has been previously identified by Broad Range Tuning (101). Once both stages of precision are at rest, the final content source selection may be represented by an input parameter provided to the Hosting Device (102).

Content sources may originate from an Internet Cloud (105), internal or external digital file systems or other audio sources, depicted as a storage device in (106), or both. The Hosting Device (102) may also utilize secondary digital or analog sources in order to provide offline content when live connections to a network are unavailable.

A Hosting Device (102) may provide an output (107), for controlling the invention by means of direct manipulation, either by implementing servo or stepper motor control for physical implementations, affecting the visual and possibly tactile presentation for virtual implementations, or by some other means. The incentive would be for the Hosting Device (102) to be able to “take over” from the operator for such purposes as cross-device remote control, playlists spanning multiple channels, randomized exploration of content types, etc.

### DETAILED DESCRIPTION OF THE INVENTION

The terminology used herein is for the purpose of describing particular embodiments only and is not intended to be limiting of the invention. The present disclosure is to be considered as an exemplification of the invention, and is not intended to limit the invention to the specific embodiments.

Unless otherwise defined, all terms (including technical and scientific terms) used herein have the same meaning as commonly understood by one having ordinary skill in the art and technology to which this invention belongs. It will be further understood that terms, such as those defined in commonly used dictionaries, should be interpreted as having a meaning that is consistent with their meaning in the context of the relevant art, technology and the present disclosure and will not be interpreted in an idealized or overly formal sense unless expressly so defined herein.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In order to achieve a new sense of immediacy and ease for the consumer of digital content, a “search-less” and metadata-free experience may be achieved by means of restricted precision applied to the selection process and “one touch” access to digital content, so as to identify its source, type or other traits by implication of the consumption process which is already underway.

Responding to human touch, or its appropriate facsimile for special cases, one or more devices may be manipulated so as to change what may be understood to be their current position. Such devices may be implemented virtually, as a presentation on a computer screen, or mechanically as a rotating or sliding knob, or by other means. Such implementations may vary within a single embodiment.

The current position of such devices are not only understood by the human operator but also by a hosting device that can read this position and determine if a precise selection has been made. If so, the hosting device is presumed capable of connecting to some source of digital content, either stored or remotely accessed, and making that content immediately available for consumption by the operator.

A limitation on precision is deliberately imposed on every selection device for two or more purposes:
1. To allow a final selection per device to be made by the operator by simply ceasing to manipulate the device, requiring as little demand as possible upon human dexterity
2. To allow a limited number of choices for content selection by the hosting device, creating artificial scarcity in order to promote the most relevant and desirable content to a consuming audience
3. Other purposes, such as to allow a practical implementation of tactile feedback per number of rest positions which correspond to final selections, which may be coupled with a combined virtual implementation in some embodiments such as may be suitable for a mobile smart phone, which renders an implementation on its screen and emits vibrations at every virtual detent during manipulation, or to allow a readable number of discrete numerals to highlight or “light up” in a swarm around the dial

Multiple selection devices may be arranged within an embodiment such that each device represents a different level of precision and presumes that one digit of a total representation in some radix has been identified by a previous device. In this way, a final selection value may be calculated by multiplying the place values as represented by each device's individual selection. In some embodiments, the successive order of precision may be defined by their placement within a design or by other visual cues, such as one large knob for “rough tune” followed by a smaller knob for “fine tune”. In such embodiments, the assignment to each device of a successively precise identification leading to a final selection is referred to herein as a “stage of precision”.

Similar to vintage radio, television and computers, sound effects may be applied by the hosting device in one or more embodiments as each stage of precision is manipulated. Examples are: A.M. fade between channels, F.M. “hiss and thump” between instances of stable PLL locking, heterodyne S.W. whine or sideband distortion, and the audible sounds emanating from antiquated dial-up modems during the initial connection process that employed PCM standards such as V.92. Whenever these effects disappear, content is available to the consumer.

Any or all stages of precision may be calibrated by means of visual markings. If so calibrated these markings should represent some sort of sequence or related meaning within a sequence, such as numerals in an alphabet or number system, signs of the zodiac, emoticons, or other ideograms.

Any stage of precision may differ from any other by its level of precision. In one embodiment, a large physical knob could be labeled with calibration marks evenly-spaced around its circumference as “00” through “99”. This knob would constitute the first of two stages in this embodiment, being the Broad Range Tuning control and capable of slightly less than one full rotation. In this embodiment, the second stage would constitute a Fine Tuning control implemented as a smaller knob with non-specific calibration marks. This device could be capable of 10 full turns of rotation and able to select 10 sources per turn, yielding a total of 10K sources for the complete implementation, by simple multiplication.

It is presumed that if a calibration mark has a sequential reference or intrinsic iconic meaning that there is a sufficiently approximate correlation between the position of the device implementing a stage of precision and the mark being visually selected, also possibly indicated by the absence of an audible cue or a tactile response. In one embodiment, this could be an arrow, dot or light embedded near the circumference of a rotating knob. When approximately correlated to its calibration marks, when at rest the knob will cause the hosting device to attach to digital content that corresponds, perhaps arbitrarily, to an associated mark.

Once connected by the human manipulation of one or more stages of precision, access to content is immediate and complete. While under manipulation, every effort should be made by the implementation to provide “snippets” of immediately connected material so that ready identification of the source and type of the material may be made intrinsically through consumption, with an arbitrary level of accuracy through interpretation or by receiving some form of self-identification provided by the content itself, perhaps periodically. One technique for providing this capability is to supply small buffers of all available material to all channels during the selection process, possibly adding a short “station identification” snippet, broadcast or derived locally from metadata and mixed in with the currently playing content.

Since levels of precision are applied to every stage there may be an arbitrary but strategic limit applied to the number of choices at each stage. A limit value may, but is not required to, be chosen to facilitate smooth operation with limited human dexterity or create a lesser or greater degree of scarcity when combined with subsequent stages. When an implementation strikes an advisable balance, the broadcast network supplying the content can take advantage of the total number of channels and promote the most premium and popular content as best suits the implementation.

### REFERENCES

Incorporated herein by reference:
1. “AM Broadcasting”. Retrieved from https://en.wikipedia.org/wiki/AM_broadcasting.
2. “FM Broadcasting”. Retrieved from https://en.wikipedia.org/wiki/FM_broadcasting.
3. “Phase-Locked Loop”. Retrieved from https://en.wikipedia.org/wiki/Phase-locked_loop.
4. “Shortwave Radio”. Retrieved from https://en.wikipedia.org/wiki/Shortwave_radio.
5. “Radio Receiver—Superhet”. (June 2019) Retrieved from https://reviseomatic.org/help/2-radio/Radio %20Receiver %20-%20Superhet.php.
6. “Single-Sideband Modulation”. Retrieved from https://en.wikipedia.org/wiki/Single-sideband_modulation.
7. “Modem”. Retrieved from https://en.wikipedia.org/wiki/Modem.
8. “Pulse-Code Modulation”. Retrieved from https://en.wikipedia.org/wiki/Pulse-code_modulation.
9. “V.92”. Retrieved from https://en.wikipedia.org/wikiN.92.
10. “English Alphabet”. Retrieved from https://en.wikipedia.org/wiki/English_alphabet.
11. “Numeral System”. Retrieved from https://en.wikipedia.org/wiki/Numeral_system.
12. “Zodiac”. Retrieved from https://en.wikipedia.org/wiki/Zodiac
13. “List of Emoticons”. Retrieved from https://en.wikipedia.org/wiki/List_of_emoticons.
14. “Ideogram”. Retrieved from https://en.wikipedia.org/wikUldeogram.

What is claimed is:

1. A method of human-machine interaction that provides digital content to a consumer instantly by eliminating searching, browsing or other preliminary selection operations which are predicated on having to receive and review metadata.

2. One or more devices according to claim 1, implemented virtually or physically in any embodiment, that can respond to human manipulation and indicate their current position based on said manipulation, thereby providing a means of initiating a digital content selection action on the part of a consumer.

3. A deliberate limitation on said devices according to claim 2 for the purpose of limiting excess reliance on human dexterity in order to achieve a rest position that indicates a selected choice, creating scarcity based on limited availability for the benefit of content promotion by the broadcast network, or for other purposes.

4. Presuming the availability of a hosting device that can provide digital content to a consumer, such as a mobile application connected to an Internet streaming service, that the described human-machine interaction will inform the hosting device when the operator's decision-making is proceeding and when a final decision has been made, so that the host may provide indications of the available choices not yet finalized, by means of various visual and audible cues, and provide content immediately to the operator for consumption when a final decision is reached.
